(19) United States
(12) Patent Application Publication
(10) Pub. No.: US 2025/0178946 A1
(43) Pub. Date: Jun. 5, 2025

(54) METHOD OF FORMING A MULTICORE PREFORM AND FIBER

(71) Applicant: CORNING INCORPORATED, CORNING, NY (US)

(72) Inventors: Ming-Jun Li, Horseheads, NY (US); Jeffery Scott Stone, Addison, NY (US)

(21) Appl. No.: 18/956,962

(22) Filed: Nov. 22, 2024

Related U.S. Application Data
(60) Provisional application No. 63/605,831, filed on Dec. 4, 2023.

(51) Int. Cl. C03B 37/012; C03B 37/027

(52) U.S. Cl. CPC C03B 37/01222; C03B 37/01231; C03B 37/01248; C03B 37/0126; C03B 37/027; C03B 2203/23; C03B 2203/34

(57) ABSTRACT

A method of forming a multicore fiber comprises the steps of drilling a plurality of holes in a soot blank, inserting a plurality of graphite rods into the plurality of holes to form a soot preform assembly, consolidating the soot preform assembly in a high temperature furnace to form a glass preform assembly, removing the plurality of graphite rods from the glass preform assembly to form a solid glass preform containing multiple holes, inserting a plurality of glass core canes into the holes to form a multicore preform, placing the multicore preform in a draw furnace, and drawing multicore fiber from the multicore preform.

This application claims the benefit of priority of U.S. Provisional Application Ser. No. 63/605,831 filed on Dec. 4, 2023, the content of which is relied upon and incorporated herein by reference in its entirety.

### FIELD OF THE DISCLOSURE

The present disclosure generally relates to a multicore fiber, and more particularly relates to a method of making a multicore preform for drawing multicore fiber.

### BACKGROUND OF THE DISCLOSURE

Multicore fibers are typically used for enhanced optical fiber capacity for long-distance transmission and data center networks. To make multicore fiber transmission of optical signals viable, a cost-effective multicore fiber manufacturing process is needed. Current manufacturing processes typically require expensive high precision ultrasonic drilling in glass preforms to form holes for receiving core canes to form a multicore preform. It would be desirable to provide for a method of forming a multicore fiber that is cost effective and easy to manufacture.

### SUMMARY OF THE DISCLOSURE

According to a first aspect of the present disclosure, a method of forming a multicore preform for forming multicore fiber comprises the steps of drilling a plurality of holes in a soot blank, inserting a plurality of graphite rods into the plurality of holes to form a soot preform assembly, consolidating the soot preform assembly in a high temperature furnace to form a glass preform assembly, removing the plurality of graphite rods from the glass preform assembly to form a solid glass preform containing multiple holes, and inserting a plurality of glass core canes into the holes to form a multicore preform.

According to a second aspect of the present disclosure, each of the plurality of graphite rods has a cylindrical shape.

According to a third aspect of the present disclosure, each of the plurality of glass core canes has a cylindrical shape.

According to a fourth aspect of the present disclosure, the soot blank has a density greater than 0.8 g/cm³.

According to a fifth aspect of the present disclosure, the density of the soot blank is greater than 1.0 g/cm³.

According to a sixth aspect of the present disclosure, the density of the soot blank is less than or equal to 1.6 g/cm³.

According to a seventh aspect of the present disclosure, the step of consolidating the soot preform occurs at a temperature in the range of about 1300° C. to 1500° C.

According to an eighth aspect of the present disclosure, the plurality of graphite rods have a diameter slightly less than a diameter of the drilled plurality of holes.

According to a ninth aspect of the present disclosure, the method further comprises the step of cooling the glass preform assembly prior to removing the plurality of graphite rods.

According to a tenth aspect of the present disclosure, the method comprises the step of forming the soot blank from silicon dioxide.

According to an eleventh aspect of the present disclosure, the method comprises the steps of placing the multicore preform in a draw furnace and drawing multicore fiber from the multicore preform.

According to an twelfth aspect of the present disclosure, a method of forming a multicore fiber comprises the steps of drilling a plurality of holes in a soot blank, inserting a plurality of graphite rods into the plurality of holes to form a soot preform assembly, consolidating the soot preform assembly in a high temperature furnace to form a glass preform assembly, removing the plurality of graphite rods from the glass preform assembly to form a solid glass preform containing multiple holes, inserting a plurality of glass core canes into the holes to form a multicore preform, placing the multicore preform in a draw furnace, and drawing multicore fiber from the multicore preform.

According to a thirteenth aspect of the present disclosure, each of the plurality of graphite rods has a cylindrical shape.

According to a fourteenth aspect of the present disclosure, each of the plurality of glass core canes has a cylindrical shape.

According to a fifteenth aspect of the present disclosure, the soot blank has a density greater than 0.8 g/cm³.

According to a sixteenth aspect of the present disclosure, the density of the soot blank is greater than 1.0 g/cm³.

According to a seventeenth aspect of the present disclosure, the density of the soot blank is less than or equal to 1.6 g/cm³.

According to an eighteenth aspect of the present disclosure, the step of consolidating the soot preform occurs at a temperature in the range of about 1300° C. to 1500° C.

According to a nineteenth aspect of the present disclosure, the plurality of graphite rods have a diameter slightly less than a diameter of the drilled plurality of holes.

According to a twentieth aspect of the present disclosure, the method comprises the step of cooling the glass preform assembly prior to removing the plurality of graphite rods.

According to a twenty-first aspect of the present disclosure, the method comprises the step forming the soot blank from silicon dioxide.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the claims. The accompanying drawings are included to provide a further understanding and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is an end view of a multicore fiber having a plurality of cores, according to a first embodiment;

FIG. 2 is an end view of a multicore fiber having a plurality of cores, according to a second embodiment;

FIG. 3 is an end view of a multicore fiber having a plurality of cores, according to a third embodiment;

FIG. 4 is an end view of a multicore fiber having a plurality of cores, according to a fourth embodiment;

FIG. 5A is an upper perspective view of a cylindrical soot blank used to form a multicore preform used to draw multicore fiber;

FIG. 5B is an upper perspective view of the soot blank following the step of drilling holes in the soot blank;

FIG. 5C is an upper perspective view of the soot blank further illustrating graphite rods inserted within the drilled holes;

FIG. 5D is an upper perspective view of the soot blank in a consolidation furnace for forming a consolidated glass preform;

FIG. 5E is an upper perspective view of the consolidated glass preform with the graphite rods removed to expose holes;

FIG. 5F is an upper perspective view of the consolidated preform further illustrating the insertion of glass core canes into the holes to form a multicore preform;

FIG. 6 is a schematic diagram illustrating an optical fiber production system used for forming multicore fiber from the multicore preform;

FIG. 7 is a flow diagram illustrating a method of forming the multicore preform and multicore fiber; and

FIG. 8 is a relative refractive index profile of the core.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

The following detailed description represents embodiments that are intended to provide an overview or framework for understanding the nature and character of the claims. The accompanied drawings are included to provide a further understanding of the claims and constitute a part of the specification. The drawings illustrate various embodiments, and together with the descriptions serve to explain the principles and operations of these embodiments as claimed.

As used herein, “multicore fiber” refers to a multicore optical fiber having multiple cores contained within a surrounding cladding, where the cores have a higher refractive index than the cladding and each core of the multicore fiber acts independently to transmit an optical signal at one or more wavelengths by waveguiding, and the one or more wavelengths include 1550 nm.

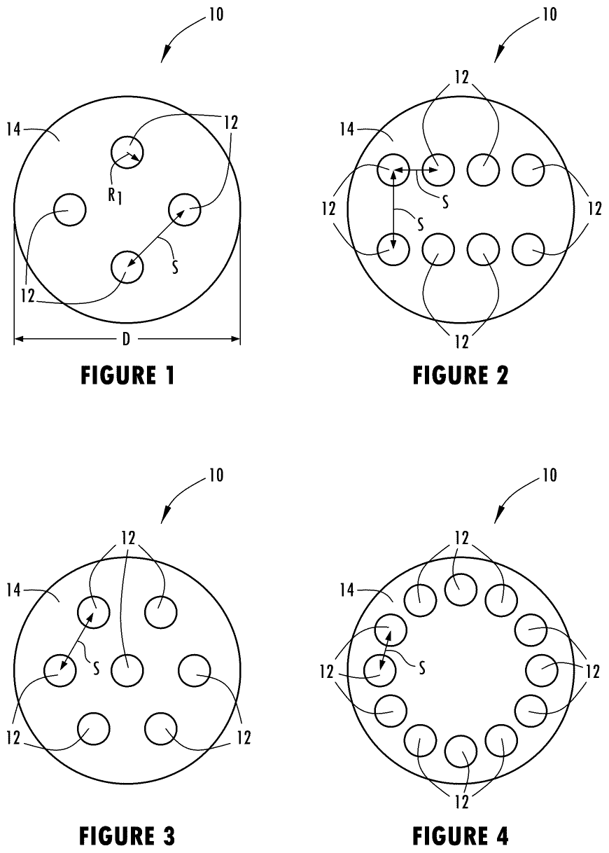

Referring to FIGS. 1-4, the terminal end of bare uncoated multicore fibers 10 having a plurality of cores 12 surrounded by a cladding 14 are illustrated, according to various embodiments. In each embodiment, the multicore fiber 10 may be formed in a furnace from a multicore preform as shown and described herein. The plurality of cores 12 may be glass cores formed from glass canes and each having a circular shape in cross-section and spaced apart from one another. The cladding 14 is shown having a generally circular end shape or cross-sectional shape in the embodiments illustrated in FIGS. 1-4. The cladding 14 is formed from a soot preform that is heated and consolidated in a furnace to form a glass preform. The plurality of cores 12 extend through the length of the fiber and are illustrated spaced apart from one another and separated by the cladding 14. Each multicore fiber 10 contains at least two core elements and therefore has a plurality of cores 12. It should be appreciated that two or more core elements may be included in the multicore fiber 10 in various numbers of cores and various fiber arrangements. While the plurality of cores 12 are shown and described herein having a circular cross-section, it should be appreciated that the plurality of cores 12 may have other shapes and sizes, such as elliptical or oblong shapes, for example.

The multicore fiber 10 employs a plurality of glass cores 12 spaced from one another and surrounded by the cladding 14. The plurality of cores 12 and the cladding 14 may be made of glass or other optical fiber material and may be doped suitable for optical fiber. In one embodiment, the shape of the multicore fiber 10 may be a circular end shape or cross-sectional shape as shown in FIGS. 1-4. In other embodiments, the shape of the fiber 10 may be a square or rectangular end shape or cross-sectional shape, for example. According to other embodiments, other non-circular cross-sectional shapes and sizes may be employed including hexagonal and various polygonal forms.

The multicore fiber 10 is an optical fiber that includes a plurality of cores 12, each capable of communicating light signals between transceivers including transmitters and receivers which may allow for parallel processing of multiple signals. The multicore fiber 10 may be used for wavelength division multiplexing (WDM) or multi-level logic or for other parallel optics of spatial division multiplexing, for example. The multicore fiber 10 may advantageously be aligned with and connected to various devices in a manner that allows for easy and reliable connection so that the plurality of cores 12 are aligned accurately at opposite terminal ends with like communication paths in connecting devices.

The multicore fiber 10 illustrated in a first embodiment shown in FIG. 1 has four (4) circular shaped cores 12 arranged in a circular cross-sectional area of the cladding 14 in a 2×2 array having two rows and two columns or cores 12 and surrounded by the glass cladding 14. Each of the plurality of cores 12 has a radius R₁. Each core may have one or more concentric glass segments with different refractive indices that are designed to confine light in the core region to enable waveguiding of the light. In addition, the adjacent cores 12 are spaced apart from each other by a distance S (center-to-center core spacing) which is shown as a distance between the centers of adjacent cores 12. The cladding 14 is shown having a circular cross-sectional diameter D.

In the second embodiment shown in FIG. 2, eight (8) cores 12 are shown arranged in a circular cross-sectional area of the cladding 14 in a 2×4 array having four columns and two rows of cores 12. The spacing S between adjacent cores 12 in each row is less than the spacing between the two columns of cores 12, in one example.

In the third embodiment shown in FIG. 3, a seven (7) core structure is shown arranged in a hexagonal lattice having six (6) cores 12 arranged in a ring-shaped pattern within the circular cross-sectional area of the cladding 14 and a seventh core 12 located in the center of the ring-shaped pattern of the six cores. The cores 12 are evenly spaced by spacing S within the ring shape pattern.

In the fourth embodiment shown in FIG. 4, twelve (12) cores 12 are illustrated arranged in a ring-shaped pattern within the circular cross-sectional area of the cladding 14. The cores 12 are equally spaced within the ring shape pattern.

The four embodiments of multicore fibers 10 shown herein are examples of multicore fibers that may be produced according to the method of forming a multicore preform and fiber as shown and described herein. It should be appreciated that other shapes and sizes of the cladding 14 and other shapes, sizes, numbers of cores, and arrangements of the plurality of cores 12 may be presented within a multicore fiber 10, according to the teachings of the disclosure presented herein.

In the embodiments shown in FIGS. 1-4, the cladding 14 has a generally round end shape or cross-sectional shape with diameter D. For some optical fiber applications, the cladding diameter D is preferably less than 500 micrometers to ensure that the multicore fiber 10 remains flexible. Preferably, the diameter D of the cladding 14 is less than 250 micrometers. In some embodiments, the diameter D is between 120 micrometers and 130 micrometers, such as 125 micrometers. In the various embodiments, the spacings S between two adjacent cores 12 is preferably greater than 20 micrometers to ensure low crosstalk between the cores, and more preferably greater than 30 micrometers.

The plurality of cores 12 in the various embodiments of multicore fibers 10 may have a simple step-shaped refractive index profile according to one example or a graded refractive index profile according to another example. In some embodiments, the refractive index profile of the core may include multiple segments. The refractive index in each segment may include a simple step or graded index profile. The refractive index profile is the relationship between the relative index percent (4%) and the optical fiber average core radius (as measured from the centerline of the core) over a selected segment of the fiber. A low index trench can also be placed in a core segment to increase light confinement in the core. The core may include a core segment and a cladding segment. The maximum index of the core is preferably greater than the cladding index. Preferably, the relative refractive index of the core 12 to the cladding is greater than 0.2%, preferably greater than 0.3%, and may be between 0.3 to 2.0%, according to one example.

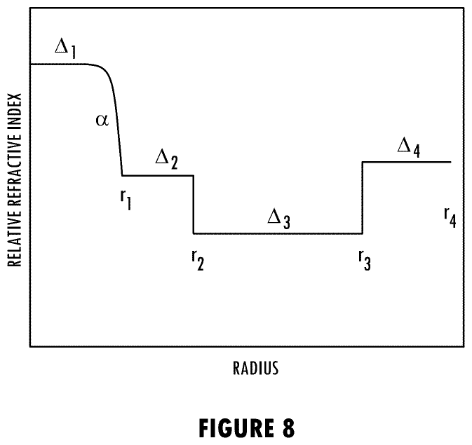

One example of the refractive index profile of Core 12 is shown schematically in FIG. 8. The profile may include four segments: central core, inner cladding, low index trench, and outer cladding. The central core segment can have a a-profile with relative refractive index of Δ₁, and radius r₁. The core segment is surrounded by an inner cladding segment with refractive index of 42, and radius r₂. The low index trench can be placed around the inner cladding to increase light confinement in the core. The low index trench has refractive index of 43, and radius r₃. The outer cladding surrounds the low index trench with a refractive index of refractive index of 44, and radius r₄. In the embodiment depicted in FIG. 8, Δ₁>Δ₄; Δ₁>Δ₂, Δ₃, Δ₄; and Δ₃<Δ₄. Preferably the relative refractive index Δι of the core relative to the relative refractive index of the outer cladding 44 is between 0.2% and 0.5%, more preferably between 0.25% and 0.4%. The core radius r₁ is selected in the range of 3 to 10 μm, so that the core is single mode at an operating wavelength, for example 1310 nm, or 1550 nm. The low index trench has a relative refractive index Δ₃ in the range of −0.7% to −0.1%, and a width w=r₃−r₂ in the range of 1 to 6 μm. The trench can be offset by a distance d=r₂−r₁ from the core. The offset d is between 0 to 5 μm. The inner cladding 42 and the outer cladding Δ₄ may be the same or different. In embodiments, the core may include only the central core segment, and the radius of Core 12 is R₁=r₁. In embodiments, the core may include two segments, the central core and the inner cladding, and the radius of Core 12 is R₁=r₂. In embodiments, the core may include three segments, the central core, the inner cladding and the trench, and the radius of Core 12 is R₁=r₃. In embodiments, the core may include four segments, the central core, the inner cladding, the trench and the outer cladding, and the radius of Core 12 is R₁=r₄.

The core radius corresponds to the core radius R₁ may be in the range of two to fifteen micrometers (2-15 μm), and more preferably in the range of three to ten micrometers (3-10 μm), according to one embodiment. The core 12 can be single mode or multimode at an operating wavelength depending on the applications. The low index trench may have a delta in the range of −0.7% to −0.1%, and a width in the range of one to six micrometers (1-6 μm). The trench can be offset by a distance from the core 12. The offset may be between zero to five micrometers (0-5 μm), according to one embodiment.

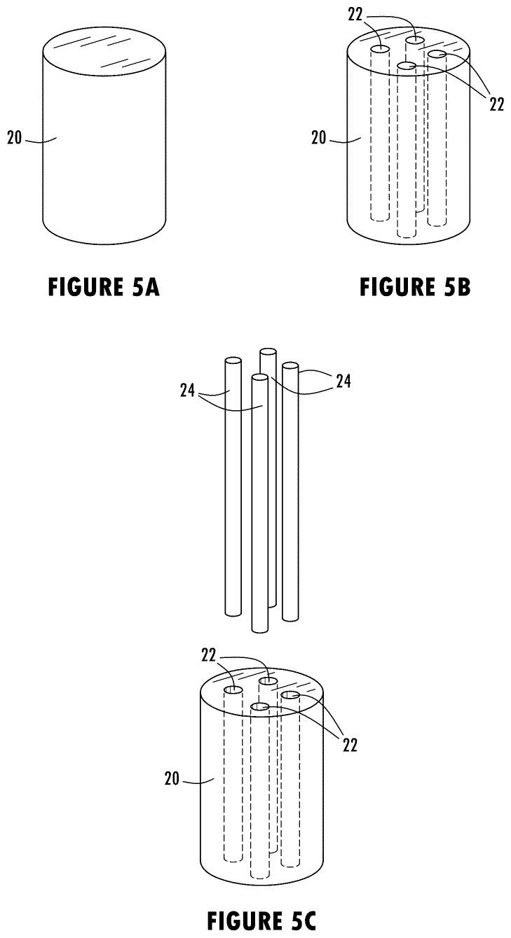

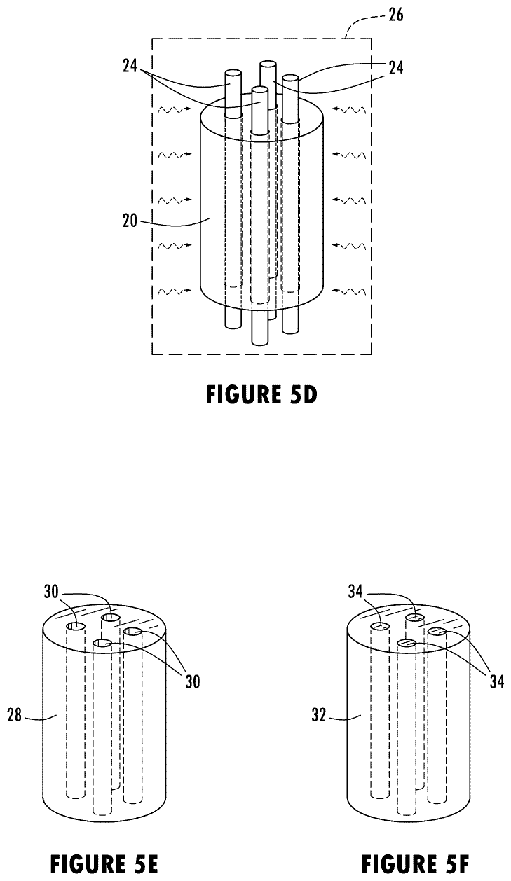

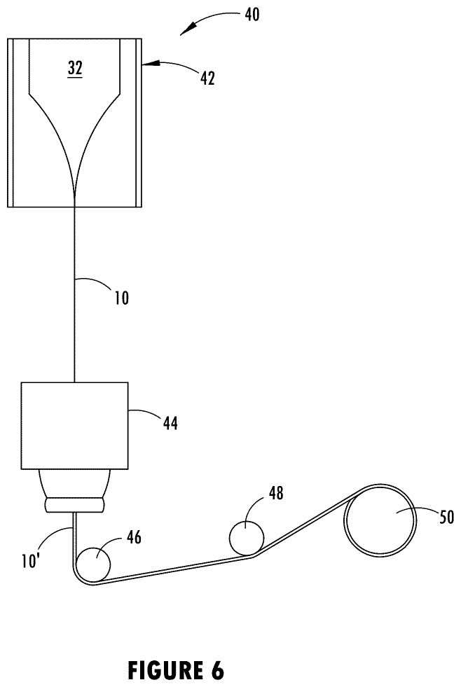

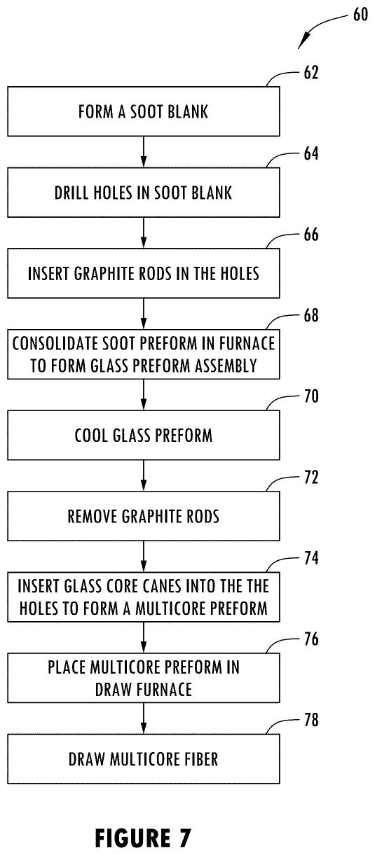

The multicore fiber 10 having the plurality of cores 12 may be formed in one example with the optical fiber production system 40 shown in FIG. 6 by drawing the multicore fiber from a glass preform 32 that may be made according to the method shown in FIGS. 5A-5F and FIG. 7. In the embodiment shown in FIGS. 5A-5F and FIG. 7, the method of manufacturing the multicore fiber includes forming a multicore preform having a plurality of core canes and a cladding glass surrounding the canes. The multicore preform 32 is placed in a furnace in the multicore optical fiber production system 40 and heated to draw the multicore fiber.

The method of making the multicore preform and multicore fiber is identified by identifier 60 in FIG. 7. Method 60 includes the step 62 of forming a soot blank. One example of a soot blank is shown in FIG. 5A and may include a silica blank, made of silicon dioxide (SiO₂). The soot blank 20 may be made by an outside vapor deposition (OVD) according to one example or a vapor axial deposition process (VAD) according to another example. The soot blank 20 could also be made using a soot-pressing process, according to a further example, where loose soot particles are compressed into the desired shape. The soot blank 20 is shown in FIG. 5A having a generally cylindrical shape. According to one example, the soot blank 20 has a diameter in the range of about 40 mm to 200 mm and a length in the range of about 10 cm to 200 cm. In order to have adequate mechanical strength for the drilling step 64, the density of the soot blank 20 is desired to be greater than 0.8 g/cm³, and more preferably greater than 1.0 g/cm³, where density refers to the average density of the soot blank 20 It is preferred that the density not be too high, such that the soot blank 20 becomes too hard for adequate drilling. A preferred range for the soot blank density is in the range of between 1.0 and 1.6 g/cm³. The soot density after an OVD or VAD laydown is typically around 0.5 g/cm³. To increase the density to the desired range, the soot blank 20 may be pre-sintered in a furnace at a temperature lower than the consolidation temperature used to form glass from the soot. For example, the soot blank 20 of about 3,000 g may be pre-sintered in a furnace at a temperature of about 1300° C. for three hours in a helium atmosphere which will increase the soot density to about 1.2 g/cm³. The exposure time and temperature will change depending on the size of the soot blank 20. The temperature and time for pre-sintering may be selected such that the density of the soot blank 20 is larger than 1.0 g/cm³, more preferably larger than 1.2 g/cm³, but less than 1.5 g/cm³.

Following formation of the soot blank 20 with a density as noted above, method 60 proceeds to step 64 to drill holes 22 in the soot blank 20. Referring to FIG. 5B, in the example shown, four cylindrical holes 22 are shown drilled longitudinally into the top surface of the soot blank 20. In this example, the four holes 22 correspond to a shape and number of cores sufficient to produce a multicore preform that, in turn, may produce a multicore fiber according to the embodiment shown in FIG. 1. The holes 22 may be drilled with a mechanical drill with a drill bit to achieve a cylindrical hole having a diameter in the range of about 5 mm to 50 mm and a depth of about 10 cm to 100 cm. The drilling of the holes 22 occurs after the pre-sintering (or other densification such as mechanical compression of soot particles in a soot pressing process) of the soot blank 20 which has the desired density sufficient to allow and withstand the drilling. The holes 22 may be drilled to include a closed bottom end such as, for example, leaving a solid bottom of 1-3 cm. The closed bottom end can hold the graphite rods in the next process step. It should be appreciated that other patterns of multicore structures defining the holes 22 may be drilled into the soot blank 20 to make other shapes and sizes of multicore preforms and multicore fibers.

Next, method 60 includes the step of inserting graphite rods into the drilled holes in step 66. The insertion of the graphite rods 24 into the respective holes 22 of the soot blank 20 is illustrated in FIG. 5C. The graphite rods 24 are shown each having a cylindrical shape sized to fit within a corresponding hole 22. It should be appreciated that the diameter of the graphite rods 24 (e.g., 10 mm) are slightly smaller than the diameter of the holes 22 (e.g., 11 mm). The diameter of graphite rods 24 is preferably at least 80%, or at least 90% of the diameter of the holes 22. The graphite rods 24 may have a diameter in the range of about 4 mm to 49 mm. According to other embodiments, other types of materials can be used for the rods 24, such as alumina, silicon carbide, and materials that can withstand consolidation temperatures without deformation, which consolidation typically occurs up to about 1500° C., such as between 1300° C. and 1500° C. In one embodiment, soot blank 20 comprises or consists of silica and the rods comprise a material other than silica or lack silica.

With the graphite rods 24 inserted within the soot blank 20, method 60 proceeds to step 68 of consolidating the soot preform in a furnace to form a glass preform assembly 28. The consolidation of the soot preform is shown in FIG. 5D with the soot blank 20 and graphite rods 24 inserted within a consolidation furnace 26. The soot blank with the graphite rods 24, is heated in the furnace to consolidate and form the glass preform assembly 28. The consolidation step may include a starting segment by heating the soot blank with graphite rods 24 to 1125° C. with a 60 minute He (or other inert gas) purge followed by a 60-120 minute chlorine drying segment. Once the drying segment has been completed, a sintering segment is initiated by down driving the blank through a sinter zone. The sinter temperature may be set in the range of 1300° C.-1500° C., such as at about 1450° C. and a down-feed velocity may be about 4.5 mm/min. After the sinter segment is completed, the glass preform assembly 28 may be raised out of the furnace hot zone and held at a temperature of 950° C. for one hour and then pulled from the furnace and allowed to cool according to step 70 of method 60. After the sinter segment, the glass of the glass preform assembly 28 is in a fully consolidated state that is essentially free of pores. When the glass of the glass preform assembly 28 is silica, the glass has a density greater than 1.9 g/cm³, or greater than 2.0 g/cm³, or greater than 2.1 g/cm³, or in a range from 1.9 g/cm³ to 2.2 g/cm³ upon completion of the sinter segment.

Following the cooling step, method 60 includes step 72 of removing the graphite rods 24 from the cooled glass preform assembly 28. This occurs after the glass preform assembly 28 is cooled down to room temperature where the graphite rods 24 may be detached from the glass preform due to the differential coefficients of thermal expansion (CTE) between the glass and the graphite, such that the graphite rods 24 contract in size by an amount greater than the glass and can therefore be easily removed by hand with tools from the holes in the glass. The CTE of silica glass is around 5.0×10⁻⁷/° C., while the CTE of graphite is about 5.0×10⁻⁶/° C., which is 10 times higher. Preferably the CTE of the rod material is more than 2 times higher of the CTE of silica, more preferably more than 5 times, and even more preferably 10 times or more. The glass preform with the graphite rods removed thereby exposes holes 30 as shown in FIG. 5E. With the graphite rods removed, the glass preform includes substantially clear glass with the plurality of round cylindrical holes 30.

Method 60 may also include the step of inserting glass core canes 34 into the holes 30 of the glass preform to form a multicore preform 32 in step 74. The glass core canes 34 may include an offset segment and a trench segment, in some embodiments. The multicore preform with the glass core canes 34 inserted in the holes is illustrated in FIG. 5F. It should be appreciated that the glass core canes 34 may be inserted in the holes 30 using a cane-in-glass process. Additional machining may be used to perfect the blank outside geometry and positions of the glass core canes 34. The holes may be etched to clean and smooth inside wall surfaces using HF based chemical etching process. The glass core canes 34 are generally cylindrical core canes that may be constructed of glass or optical fiber material that may be suitable for the manufacture of optical fiber. The glass core canes 34 may be doped, or include doped segments, and formed to provide various desired optical properties in the resulting multicore fiber drawn from the multicore preform.

In the example shown, a total of four (4) cylindrical glass core canes 34 were prepared and inserted into the holes 30 of the glass preform. To make the glass core canes 34, a glass core preform may be made by a conventional glass preform making method, such as outside vapor deposition (OVD) and consolidation process. The core preform may be redrawn into glass core canes 34 with desired diameters. The glass core canes 34 are inserted into the holes 30 of the glass preform and are supported by the closed end at bottom to form the multicore preform 32 as shown in FIG. 5F. The multicore preform may be stretched under vacuum using a redraw tower to seal the interface between glass core canes and the glass preform to fix the position of the glass core canes.

The method 60 may further include the step 76 of placing the multicore preform 32 in a draw furnace and the step 78 of drawing the multicore fiber from the multicore preform 32. Steps 76 and 78 can be achieved using the fiber production system 40 shown in FIG. 6 and described below.

The multicore preform 32 may be used to draw the multicore fiber having the plurality of cores (such as the embodiments shown in FIGS. 1-4) with a conventional fiber draw process employing the optical fiber production system 40 shown in FIG. 6, according to one embodiment. The optical fiber production system 40 is shown having a draw furnace 42 that may be heated to a temperature of about 2000° C. The multicore preform 32 is placed in the draw furnace 42 where it is heated and multicore fiber 10 is drawn therefrom, as shown by the bare optical fiber 10 output exiting the bottom of the draw furnace 42. Once the bare optical fiber 10 is drawn from the multicore preform 32, the bare optical fiber 10 may be cooled as it exits the bottom of the draw furnace 42. After sufficient cooling, the bare optical fiber 10 may be subjected to a coating unit 44 wherein one or two protective coating layers may be applied to the outer surface of the bare optical fiber 10. After leaving the coating unit 44, the coated optical fiber 10′ can pass through a variety of processing stages within the production system 40, such as tractors or rollers 46 and 48 and onto a fiber storage spool 50. One of the rollers 46 or 48 may be used to provide the necessary tension in the optical fiber as it is drawn through the entire fiber production system 40 and eventually wound onto the storage spool 50. It should be appreciated that the preform may be used to draw multicore fiber in other configurations of optical fiber production systems.

The multicore preform 32 shown in FIG. 5F is therefore exemplary of preforms that may be used to draw the multicore fiber 10 having four (4) cores 12 shown in FIG. 1. In doing so, the glass core canes 34 of the multicore preform 32 are drawn into the cores 12 of the multicore fiber 10 such that the cross-sectional shape is substantially maintained. It should be appreciated that other shapes and sizes of the preform and other numbers of glass core canes 34 may be employed to achieve a multicore fiber having a plurality of cores, according to the various embodiments shown and described herein.

### Example

A multicore fiber 10 having two cores 12 within a circular cross-section of cladding 14 was produced. The multicore fiber 10 was produced using a multicore preform process as shown in FIGS. 5A-5F. A soot blank was made by the OVD process with 2000 g silica soot. The post laydown soot density was 0.591 g/cm³. The soot blank was pre-sintered to increase its density. During the pre-sinter process, the soot blank was heated to a temperature of about 1275° C. in a helium atmosphere for 180 minutes with a 240-minute hold out of the hot zone at a temperature of about 950° C. After pre-sintering, average density of the soot blank was about 1.0 g/cm³ and the soot blank had a diameter of 68 mm. A 9″ long section of the soot blank was cut. The pre-sintered soot blank was drilled with two holes of 11 mm diameter and 16 cm depth. The distance between the centers of the two holes was about 25.4 mm. Two 10 mm graphite rods were inserted into the 11 mm drilled holes to form a soot preform assembly. A central hole was also present in the soot preform assembly following removal of the bait rod used in the initial OVD laydown of the soot blank. A glass rod was inserted in the central hole. Then, the soot preform assembly was placed in the sintering furnace for consolidation. The consolidation procedure included a 60-minute He-purge followed by a 120-minute drying with chlorine at 1125° C. Once the drying was completed, the sinter temperature was set at about 1450° C. and the soot preform assembly was down driven through the sinter furnace with a down feed velocity of 4.5 mm/min for 60 minutes. After the 60-minute sinter, the glass preform assembly was raised out of the hot zone of the sinter furnace, held at a temperature of 950° C. for one hour and then pulled from the furnace and allowed to cool.

As the glass preform assembly cooled to room temperature, the graphite rods detached from the glass of the glass preform assembly due to a difference in the thermal expansion coefficients between the glass and graphite and were easily removed. A clear glass preform with round holes was obtained. A multicore preform was formed by inserting glass core canes into the holes of the glass preform. Specifically, two 10 mm glass core canes were inserted into the holes to form a multicore preform. Each glass core cane had a step index profile with a core delta of 0.34% without an inner cladding or low index trench, and a core diameter 3.3 mm. The multicore preform was stretched slightly under vacuum using a redraw tower to seal the interface between glass core canes and glass preform to fix the position of the glass core canes. The multicore preform was then placed in the fiber production draw system and drawn into multicore fiber. The fiber had a cladding diameter about 125 μm, a core diameter of 8.9 μm, and a core spacing of 74 μm between centers of the two cores.

Various modifications and alterations may be made to the examples within the scope of the claims, and aspects of the different examples may be combined in different ways to achieve further examples. Accordingly, the true scope of the claims is to be understood from the entirety of the present disclosure in view of, but not limited to, the embodiments described herein.

It will be apparent to those skilled in the art that various modifications and variations can be made without departing from the spirit or scope of the claims.

What is claimed is:

1. A method of forming a multicore preform for forming multicore fiber, the method comprising the steps of:
drilling a plurality of holes in a soot blank;
inserting a plurality of graphite rods into the plurality of holes to form a soot preform assembly;
consolidating the soot preform assembly to form a glass preform assembly; and
removing the plurality of graphite rods from the glass preform assembly to form a glass preform containing multiple holes.

2. The method of claim 1, further comprising the step of inserting a plurality of glass core canes into the holes.

3. The method of claim 1, wherein each of the plurality of graphite rods has a cylindrical shape.

4. The method of claim 3, wherein each of the plurality of glass core canes has a cylindrical shape.

5. The method of claim 1, wherein the soot blank comprises silica and has a density greater than 0.8 g/cm³.

6. The method of claim 5, wherein the density of the soot blank is greater than 1.0 g/cm³.

7. The method of claim 6, wherein the density of the soot blank is less than or equal to 1.6 g/cm³.

8. The method of claim 1, wherein the step of consolidating the soot preform occurs at a temperature in a range of about 1300° C. to 1500° C.

9. The method of claim 1, wherein the plurality of graphite rods has a diameter 90% or greater than a diameter of the drilled plurality of holes.

10. The method of claim 1, wherein the soot blank comprises silica.

11. The method of claim 1 further comprising the step of cooling the glass preform assembly prior to removing the plurality of graphite rods.

12. The method of claim 1, further comprising inserting a glass core cane into each of the multiple holes of the solid glass preform.

13. A method of forming a multicore fiber, the method comprising the steps of:
placing the multicore preform made by the method of claim 12 in a draw furnace; and
drawing multicore fiber from the multicore preform.

14. A method of forming a multicore fiber, the method comprising the steps of:
drilling a plurality of holes in a soot blank;
inserting a plurality of graphite rods into the plurality of holes to form a soot preform assembly;
consolidating the soot preform assembly in a high temperature furnace to form a glass preform assembly;
removing the plurality of graphite rods from the glass preform assembly to form a solid glass preform containing multiple holes;
inserting a plurality of glass core canes into the holes to form a multicore preform;
placing the multicore preform in a draw furnace; and
drawing multicore fiber from the multicore preform.

15. The method of claim 14, wherein each of the plurality of graphite rods has a cylindrical shape.

16. The method of claim 14, wherein the soot blank has a density greater than 0.8 g/cm³.

17. The method of claim 16, wherein the density of the soot blank is greater than 1.0 g/cm³.

18. The method of claim 17, wherein the density of the soot blank is less than or equal to 1.6 g/cm³.

19. The method of claim 14, wherein the step of consolidating the soot preform occurs at a temperature in a range of about 1300° C. to 1500° C.

20. The method of claim 14 further comprising the step of cooling the glass preform assembly prior to removing the plurality of graphite rods.
